(19) United States
(12) Patent Application Publication
(10) Pub. No.: US 2026/0132060 A1
(43) Pub. Date: May 14, 2026

(54) ELECTRON GENERATION APPARATUS

(71) Applicant: Groon Co., Ltd., Jeonju-si (KR)

(72) Inventors: In Ho LEE, Jeonju-si (KR); Young Pyo HONG, Jeonju-si (KR); Tae Hun LEE, Jeonju-si (KR); Ji Young PARK, Jeonju-si (KR); Seon Hwa RYU, Jeonju-si (KR); Tae Yeol BAE, Jeonju-si (KR); Jin Gwang YOO, Gimje-si (KR)

(73) Assignee: Groon Co., Ltd., Jeonju-si (KR)

(21) Appl. No.: 19/244,132

(22) Filed: Jun. 20, 2025

(30) Foreign Application Priority Data
Nov. 8, 2024 (AU) 2024259856

(51) Int. Cl. C02F 1/46; H01T 19/04

(52) U.S. Cl. CPC C02F 1/4608; H01T 19/04; C02F 2303/02

(57) ABSTRACT

An electron generation apparatus according to an embodiment of the present invention includes a support structure opened at one side thereof, having an empty space therein, and having a partition wall having a predetermined height and formed at a center of the other side, an electric discharge plate provided at the other side of the support structure, an electric discharge fin module including a support plate coupled to one side of the support structure, a plurality of electric discharge fins coupled to the support plate and having protruding members protruding toward the electric discharge plate, and connection protrusions provided on the support plate at positions to which the plurality of electric discharge fins is coupled, and a circuit module disposed at one side of the electric discharge fin module and configured to apply high-voltage, high-frequency pulse power to the plurality of electric discharge fins.

### CROSS REFERENCE TO RELATED APPLICATION

This application claims priority from Australian Patent Application No. 2024259856, filed on Nov. 8, 2024, which is hereby incorporated by reference in its entirety.

### BACKGROUND

### Technical Field

The present invention relates to an electron generation apparatus used to treat water and contaminants and remove offensive odor, and more particularly, to an electron generation apparatus capable of being stacked in a vertical direction.

### Background Art

In general, a corona discharge method has been representatively known as a method or structure for producing anions under an atmospheric pressure condition. The corona discharge method is structured to induce the occurrence of corona discharge between electrodes by applying high voltages to the electrodes in accordance with respective polarities.

The corona discharge, which occurs as described above, may be classified into positive electrode corona and negative electrode corona depending on the conditions of the voltages applied to the electrodes in accordance with the respective polarities. The properties of the positive electrode corona are more easily expanded spatially than those of the negative electrode corona, but the negative electrode corona method, which produces a large number of free electrons and radicals, is being widely used in the field of industrial machines.

Further, the methods of generating free electrons, anions, and the like are classified into a pulse power method, an alternating current power method, a direct current power method, and the like depending on the types of power sources that apply power to the electrodes. In this case, a structure of an ozone generation device or an anion oxygen generation device in the related art using pulse power is configured as a fin-plate structure broadly including an electric discharge fin and a grounding part. A plus electrode has a plate shape, and a minus electrode has a fin shape. In case that pulse power is applied to the electrodes, the corona discharge is generated, and ozone or anion oxygen is generated. However, a power generation device in the related art includes a plurality of electric discharge fins and a complicated structure for applying power to the plurality of electric discharge fins, which degrades workability in replacing components.

As a related art, there is Korean Patent No. 10-0529749 (entitled ‘High-Voltage, High-Frequency-Pulse Type Electron Generation Apparatus for Treating Contaminant,’ and published on Nov. 22, 2005).

### SUMMARY

An embodiment of the present invention provides an electron generation apparatus, in which a circuit module, an electric discharge fin module, and an electric discharge plate are easily coupled and uncoupled.

Another embodiment of the present invention provides an electron generation apparatus to which an electric discharge fin having a structure for providing high conductivity and high electric discharge efficiency is applied.

Technical problems to be solved by the present invention are not limited to the above-mentioned technical problem(s), and other technical problem(s), which are not mentioned above, may be clearly understood by those skilled in the art from the following descriptions.

An electron generation apparatus according to an embodiment of the present invention may include a support structure opened at one side thereof, having an empty space therein, and having a partition wall having a predetermined height and formed at a center of the other side, an electric discharge plate provided at the other side of the support structure, an electric discharge fin module including a support plate coupled to one side of the support structure, a plurality of electric discharge fins coupled to the support plate and having protruding members protruding toward the electric discharge plate, and connection protrusions provided on the support plate at positions to which the plurality of electric discharge fins is coupled, and a circuit module disposed at one side of the electric discharge fin module and configured to apply high-voltage, high-frequency pulse power to the plurality of electric discharge fins.

In the embodiment, the plurality of electric discharge fins may include: a support member coupled to the support plate; and a protruding member protruding from the support member toward the electric discharge plate and having a plurality of tips to which an inclined surface is coupled.

In the embodiment, the number of tips provided on the protruding member may be three to ten.

In the embodiment, the plurality of electric discharge fins may be made of or coated with a conductive material including one of gold, silver, copper, aluminum, stainless, iron, and nickel.

In the embodiment, a spacing distance between the plurality of electric discharge fins and the electric discharge plate may be 3 to 40 mm.

In the embodiment, a plurality of through-holes may be formed in the electric discharge plate and correspond to the plurality of tips in a one-to-one manner, and a size of each of the plurality of through-holes may be 3 to 10 mm.

In the embodiment, the electron generation apparatus may be provided as a plurality of electron generation apparatuses stacked vertically.

In the embodiment, a plurality of electron generation parts may be stacked horizontally and vertically in an outer casing.

In the embodiment, the electron generation apparatus may further include: an electromagnetic field generator installed in an internal space of the support structure and configured to magnetize electrons and radicals released from the plurality of electric discharge fins.

In the embodiment, the circuit module may include: a main board; a plurality of connection parts connected to the main board and configured to separately apply high-voltage, high-frequency pulse power to the plurality of electric discharge fins; and a plurality of elastic connection members electrically connected to the main board, and an end of the connection protrusion may be in contact with the elastic connection member.

According to the embodiment of the present invention, it is possible to provide the electron generation apparatus, in which the circuit module, the electric discharge fin module, and the electric discharge plate are easily coupled and uncoupled, which makes it advantageous to perform maintenance, repair, and the like.

In addition, according to the embodiment of the present invention, it is possible to provide the electron generation apparatus that has a high capacity by applying the electric discharge fin with high electrical conductivity.

In addition, according to the embodiment of the present invention, it is possible to provide the electron generation apparatus capable of adjusting the electron generation capacity in accordance with the number of tips of the protruding members provided on the electric discharge fins, the sizes of the through-holes provided in the electric discharge plate, and the distances between the electric discharge fins and the electric discharge plate.

### BRIEF DESCRIPTION OF THE DRAWING

FIG. 1A is a front view illustrating an overall appearance of an electron generation apparatus according to an embodiment of the present invention.

FIG. 1B is a cross-sectional side view illustrating an overall appearance of the electron generation apparatus according to the embodiment of the present invention.

FIG. 2A is a front view illustrating a state in which the electron generation apparatuses in FIG. 1A are stacked in two stacks.

FIG. 2B is a cross-sectional side view illustrating a state in which the electron generation apparatuses in FIG. 1B are stacked in two stacks.

FIG. 3A is a front view illustrating air pipes applied to the electron generation apparatuses stacked in two stacks.

FIGS. 3B and 3C are cross-sectional side views illustrating the air pipes applied to the electron generation apparatuses stacked in two stacks.

FIG. 4A is a cross-sectional side view illustrating an electron generation part according to the embodiment of the present invention.

FIG. 4B is a view illustrating the electron generation part in FIG. 4A when viewed from the front side.

FIG. 5A is a perspective view illustrating an electric discharge fin module according to the embodiment of the present invention.

FIG. 5B is a view illustrating the electric discharge fin module in FIG. 5A when viewed from the front side.

FIG. 5C is a view illustrating the electric discharge fin module in FIG. 5A when viewed from the rear side.

FIG. 6 is a perspective view illustrating an electric discharge plate having a support structure according to the embodiment of the present invention.

FIG. 7A is a graph illustrating an experimental result related to output voltages in accordance with spacing distances between a plurality of electric discharge fins and the electric discharge plate according to the embodiment of the present invention.

FIG. 7B is a table illustrating data values according to the experimental result in FIG. 7A.

FIG. 8 is a perspective view for explaining a circuit module according to the embodiment of the present invention.

### DETAILED DESCRIPTION

Advantages and/or features of the present invention and methods of achieving the advantages and features will be clear with reference to embodiments described in detail below together with the accompanying drawings. However, the present invention is not limited to the embodiments disclosed herein but will be implemented in various forms. The embodiments of the present invention are provided so that the present invention is completely disclosed, and a person with ordinary skill in the art to which the present invention pertains can fully understand the scope of the present invention. The present invention will be defined only by the scope of the appended claims. Like reference numerals indicate like constituent elements throughout the specification.

Hereinafter, exemplary embodiments of the present invention will be described in detail with reference to the accompanying drawings.

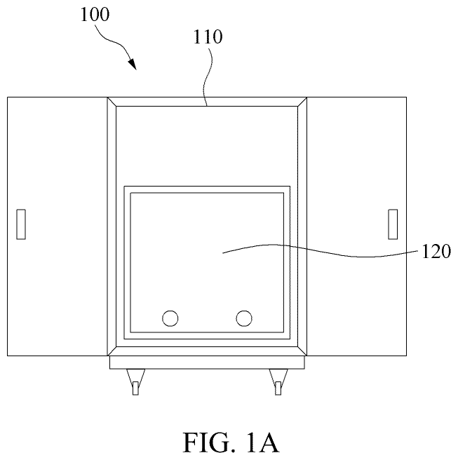

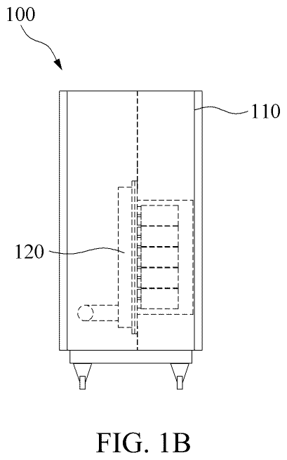

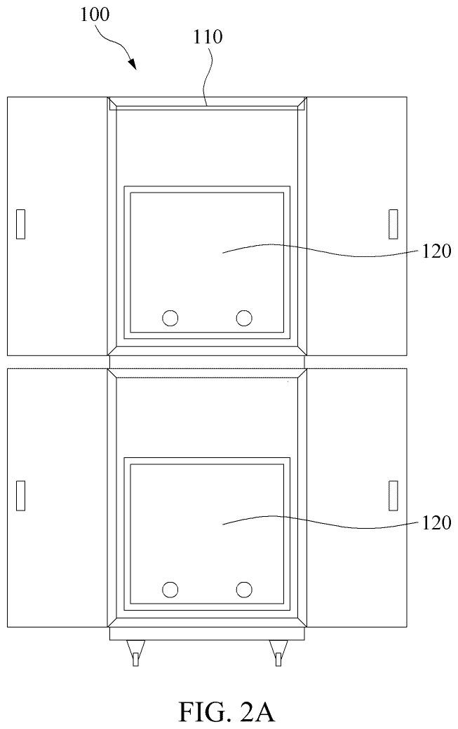

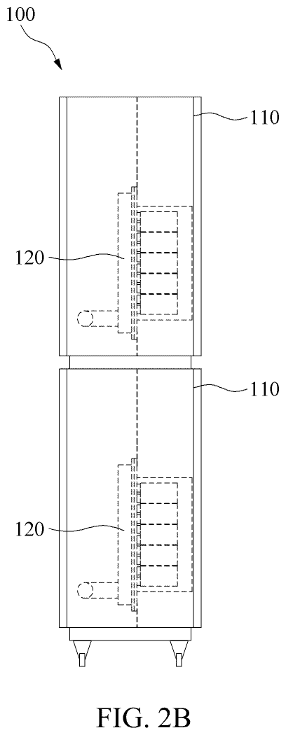

FIG. 1A is a front view illustrating an overall appearance of an electron generation apparatus according to an embodiment of the present invention, FIG. 1B is a cross-sectional side view illustrating an overall appearance of the electron generation apparatus according to the embodiment of the present invention, FIG. 2A is a front view illustrating a state in which the electron generation apparatuses in FIG. 1A are stacked in two stacks, and FIG. 2B is a cross-sectional side view illustrating a state in which the electron generation apparatuses in FIG. 1B are stacked in two stacks.

With reference to FIGS. 1A and 1B, an electron generation apparatus 100 according to an embodiment of the present invention may include an outer casing 110, and an electron generation part 120 accommodated in the outer casing 110. A controller, which controls the electron generation part 120, and a power source, which supplies power, may be accommodated together in the outer casing 100 and positioned above the electron generation part. As illustrated in FIGS. 2A and 2B, the electron generation apparatuses 100 of the present invention may be vertically stacked in two stacks and used. As necessary, the electron generation apparatuses 100 may be stacked in three or more stacks. Further, the plurality of electron generation parts 120 may also be stacked horizontally and vertically in the outer casing 100 and used.

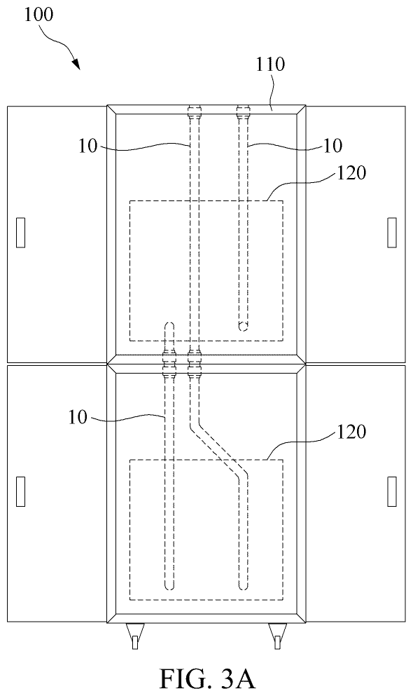

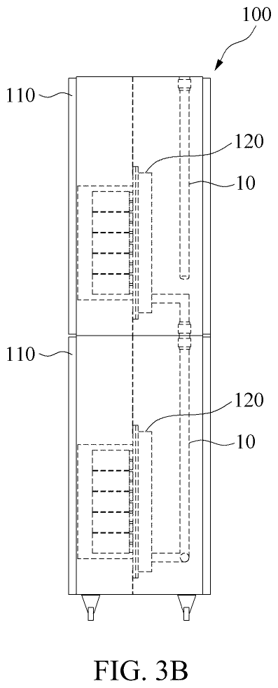

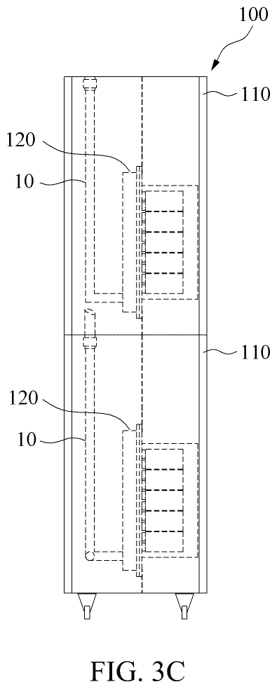

FIG. 3A is a front view illustrating air pipes applied to the electron generation apparatuses stacked in two stacks, and FIGS. 3B and 3C are cross-sectional side views illustrating the air pipes applied to the electron generation apparatuses stacked in two stacks.

With reference to FIGS. 3A to 3C, in case that the electron generation apparatuses 100 are stacked in two stacks, pipes 10 may be provided in an upward/downward direction so that airflows between the electron generation parts 120 in the respective stacks are connected in series. In this case, the pipes 10 may be provided in the electron generation apparatus 100. Specifically, air introduced into an inlet port of the pipe 10 provided at one side of a second stack may flow downward, pass through the pipe 10 provided at one side of a first stack, and enter a first opening portion. The air exiting through a second opening portion of the first stack flows upward through the pipe 10 provided at the other side of the first stack and enter a second opening portion of the second stack. The air exiting through the first opening portion of the second stack may flow upward through the pipe 10 provided at the other side of the first stack and be discharged to the outside. In this case, the pipe 10 provided at one side of the second stack and the pipe 10 provided at one side of the first stack may communicate with each other. Further, the above-mentioned structure of the pipe 10 may be equally applied to a structure with three or more stacks.

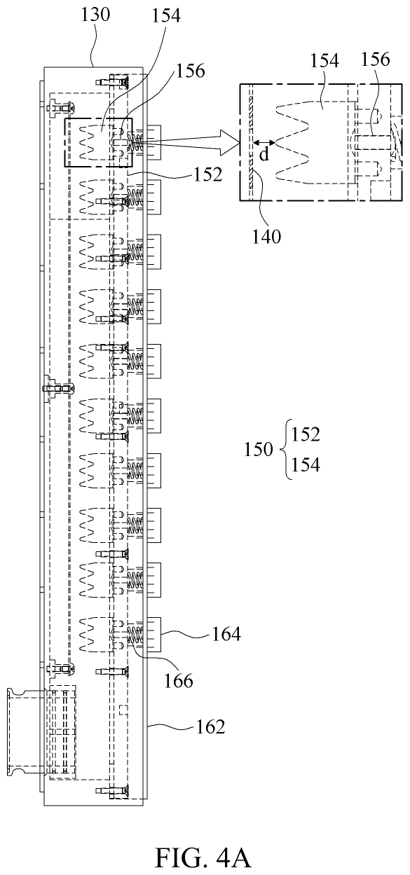

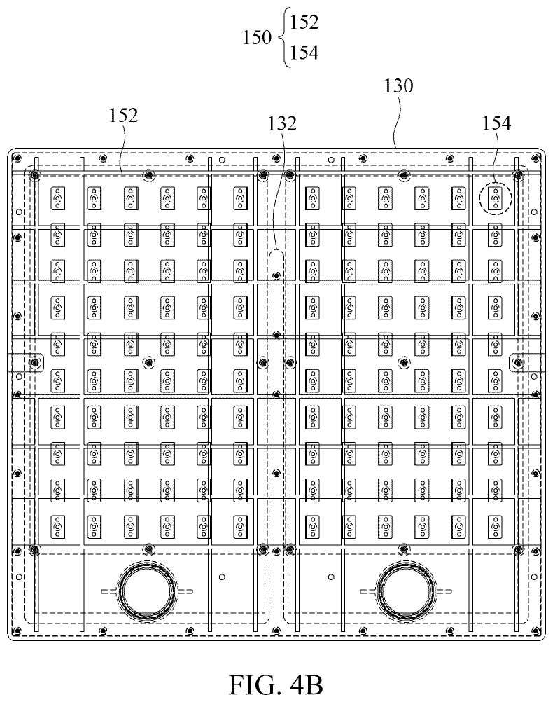

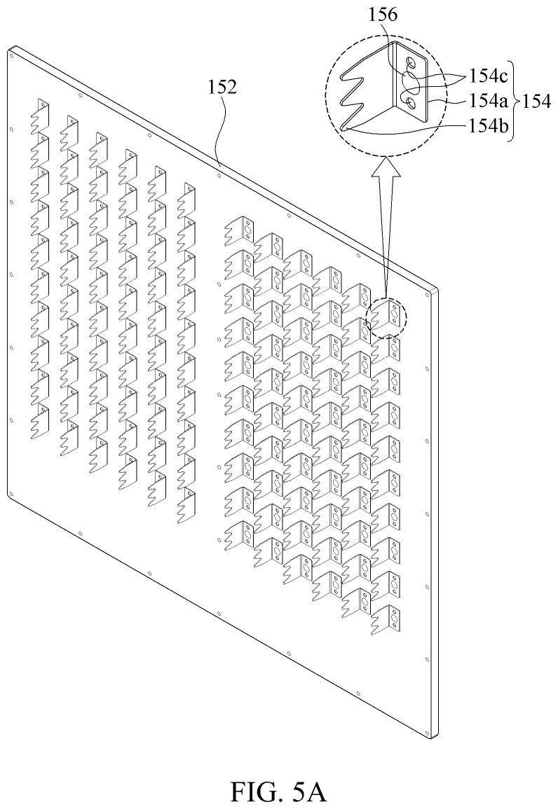

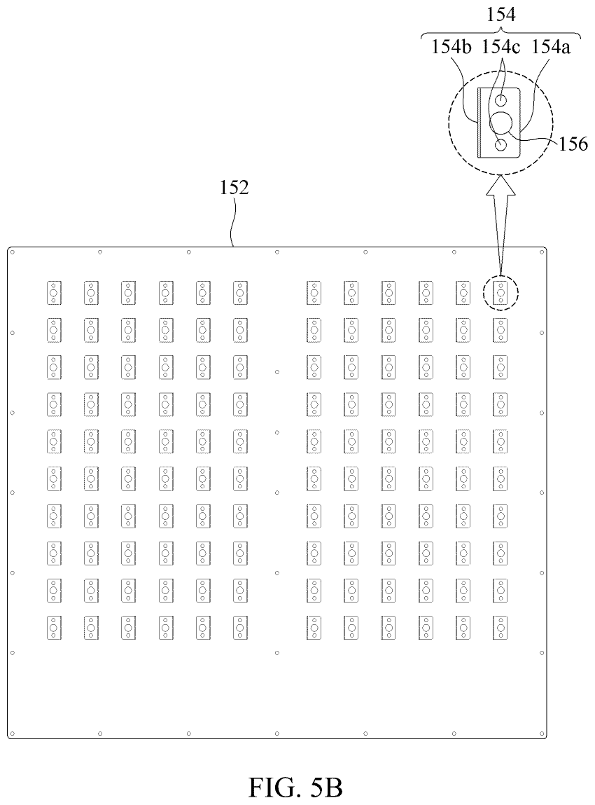

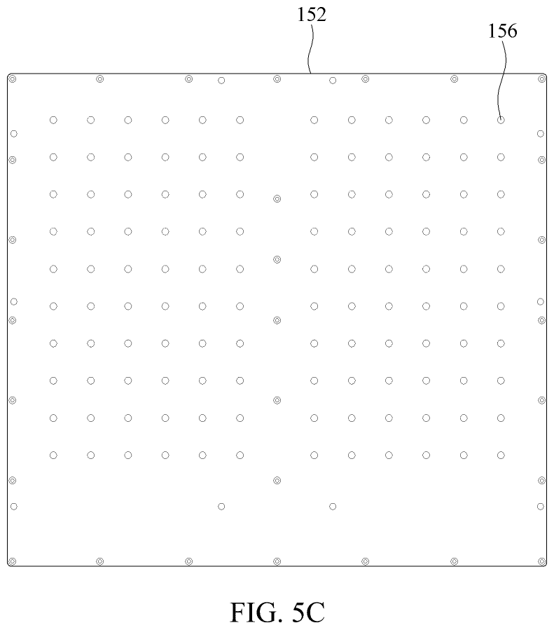

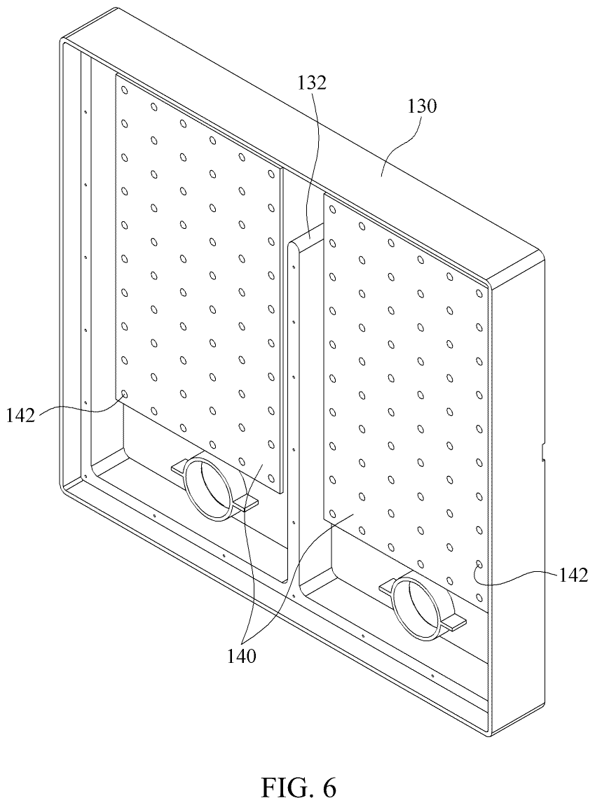

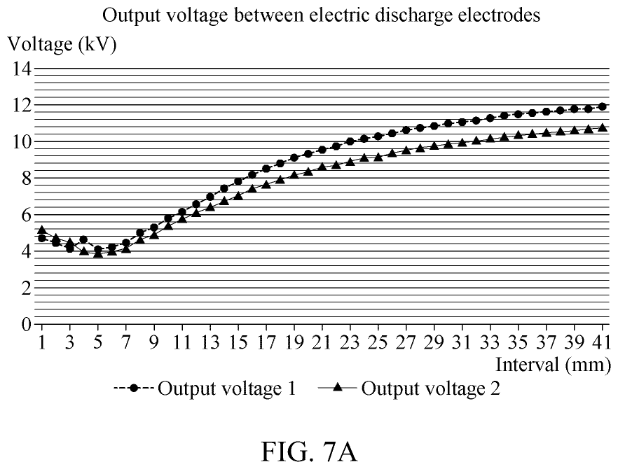

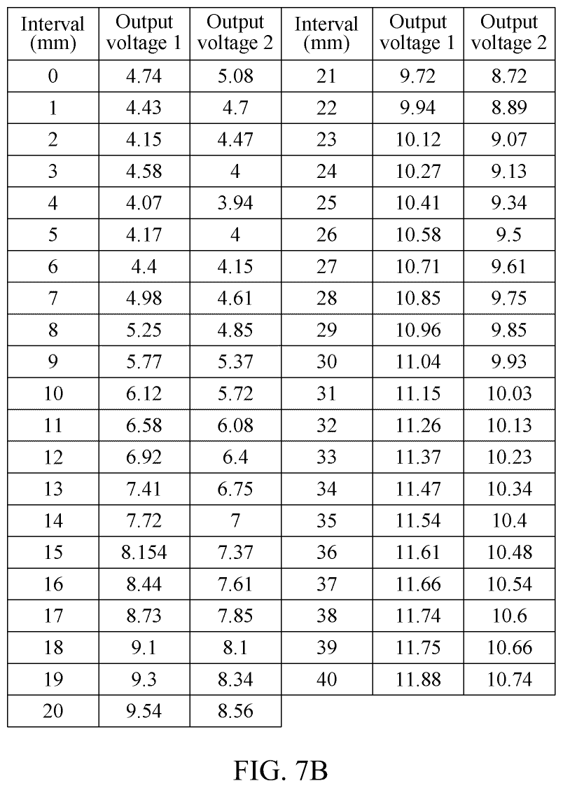

FIG. 4A is a cross-sectional side view illustrating an electron generation part according to the embodiment of the present invention, FIG. 4B is a view illustrating the electron generation part in FIG. 4A when viewed from the front side, FIG. 5A is a perspective view illustrating an electric discharge fin module according to the embodiment of the present invention, FIG. 5B is a view illustrating the electric discharge fin module in FIG. 5A when viewed from the front side, FIG. 5C is a view illustrating the electric discharge fin module in FIG. 5A when viewed from the rear side, FIG. 6 is a perspective view illustrating an electric discharge plate having a support structure according to the embodiment of the present invention, FIG. 7A is a graph illustrating an experimental result related to output voltages in accordance with spacing distances between a plurality of electric discharge fins and the electric discharge plate according to the embodiment of the present invention, FIG. 7B is a table illustrating data values according to the experimental result in FIG. 7A.

With reference to FIGS. 4A and 4B, the electron generation part may include a support structure 130, an electric discharge plate 140, and an electric discharge fin module 150.

The support structure 130 may have a main body having an empty space therein. One side of the main body is opened, and the electric discharge plate 140 may be provided at the other side of the main body. In this case, a partition wall 132 having a predetermined height may be formed at a center of the other side of the main body. The two electric discharge plates 140 may be provided side by side below the other side of the main body based on the partition wall 132.

The electric discharge fin module 150 may include a support plate 152, a plurality of electric discharge fins 154, and a plurality of connection protrusions 156.

The support plate 152 may have an approximately flat plate shape and be coupled to one opened side of the support structure 130 by various coupling means such as fitting, screwing, or bolting. The plurality of electric discharge fins 154 and the plurality of connection protrusions 156 may be coupled to the support plate 152.

The plurality of electric discharge fins 154 may include protruding members coupled to the support plate 152 and protruding toward the electric discharge plate 140.

As illustrated in FIGS. 5A and 5B, the protruding member may include a support member 154a coupled to the support plate 152, and a plurality of tips 154b protruding from the support member 154a toward the electric discharge plate 140 and coupled to an inclined surface. A coupling means, such as screwing, bolting, or riveting, may be applied to couple the support member 154a. For example, a plurality of coupling holes 154c may be provided in the support member 154a. In the present embodiment, as illustrated in FIGS. 4A and 4B, three coupling holes 154c may be provided in the support member 154a in the vertical direction, i.e., a straight direction, and the connection protrusion 156 may penetrate a center of the support member 154a. Therefore, as illustrated in FIG. 5C, only an end of the connection protrusion 156 is visible from a rear surface of the support plate 152. Therefore, a structure for fastening the electric discharge fin 154 may be simplified.

The tip 154b provided on the protruding member may be implemented as a pointy crest shape. The number of tips 154b may be three to ten. In the present embodiment, three tips 154b are applied. However, the present invention is not limited thereto.

The plurality of electric discharge fins 154 may be made of or coated with a material with high electrical conductivity. For example, the plurality of electric discharge fins 154 may be made of or coated with a conductive material containing one of gold, silver, copper, aluminum, stainless, iron, and nickel.

The plurality of connection protrusions 156 may be fixed to the support plate 152, which is disposed in a direction opposite to the direction in which the plurality of electric discharge fins 154 is provided, by fixing screws that are fixing means. The plurality of connection protrusions 156 may be made of a material with electrical conductivity. Ends of the plurality of connection protrusions 156 may be in contact with and electrically connected to elastic connection members 166 provided on a main board 162 of a circuit module 160 to be described below.

that is, the elastic connection members 166 may be in contact with and electrically connect, in a one-to-one manner, to the plurality of electric discharge fins 154 coupled to the support plate 152.

With reference to FIG. 6, the electric discharge plate 140 may have an approximately flat plate shape and be made of an electrically conductive material. The electric discharge plate 140 may be provided at the other side in an internal space of the support structure 130 and disposed to be spaced apart, at a predetermined distance, from the electric discharge fins 154 of the electric discharge fin module 150 coupled to one side of the support structure 130. A spacing distance (“d” in FIG. 4A) between the electric discharge plate 140 and the plurality of electric discharge fins 154 may be 3 to 40 mm. When the spacing distance d is too short and is 3 mm or less, heat may be generated. When the spacing distance d is too long and is 40 mm or more and, an electric discharge may not occur. In this regard, an experiment was conducted on output voltages in accordance with the spacing distance d between the plurality of electric discharge fins 154 and electric discharge plate 154, and experimental results are shown in FIGS. 7A and 7B.

The corona discharge occurs between the electric discharge fin 154 and the electric discharge plate 140, such that electrons and radicals is released from the electric discharge fin 154, which is a plus or minus electrode, to the electric discharge plate 140 that is a plus or minus electrode.

A plurality of through-holes 142 may be formed in the electric discharge plate 140 and correspond, in a one-to-one manner, to the plurality of tips 154b of the protruding members of the electric discharge fins 154. A size of each of the plurality of through-holes 142 may be 3 to 10 mm. The plurality of through-holes 142 may improve electric discharge efficiency by maintaining a shortest electric discharge distance in case that foreign substances, such as dust discharged from the electric discharge fins 154 in an initial electric discharge state, accumulate on the electric discharge plate 140.

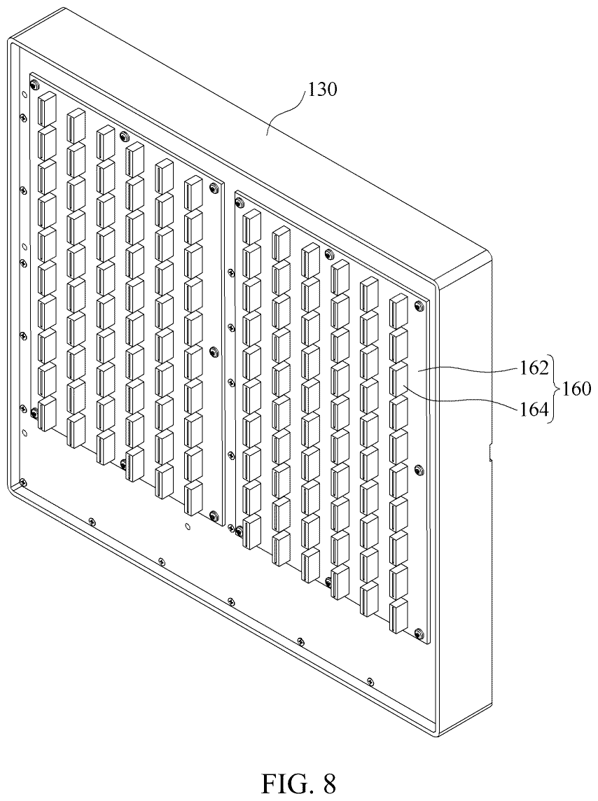

FIG. 8 is a perspective view for explaining a circuit module according to the embodiment of the present invention.

With reference to FIG. 8, the circuit module 160 may be disposed to be spaced apart from one side of the electric discharge fin module 150 and apply high-voltage, high-frequency pulse power to the plurality of electric discharge fins 154.

Specifically, the circuit module 160 may have the main board 162, and a plurality of distributed processing boards (not illustrated) connected to the main board 162.

The main board 162 has an approximately flat plate shape and has a plurality of connection parts 164 to which the plurality of distributed processing boards is connected. The plurality of connection parts 164 is positioned on the main board 162 and spaced apart from one another in the horizontal direction and the vertical direction. The plurality of connection parts 164 may be positioned on one surface of the main board 162. The plurality of connection parts 164 may be equipped with high-voltage, high-frequency pulse conversion circuits independently implemented to separately apply high-voltage, high-frequency pulse power. The plurality of distributed processing boards may each be connected to the connection part 164 provided on the main board 162 on one surface of the main board 162. The main board 162 and the plurality of distributed processing boards connected to the main board 162 may define the integrated circuit module 160 while being kept in a state of being securely coupled by the coupling means.

In this case, the main board 162 may have a plurality of elastic connection members 166 electrically connected to a lateral surface directed toward the plurality of electric discharge fins. The plurality of elastic connection members 166 may be formed on the main board 162 while corresponding to the plurality of distributed processing boards in a one-to-one manner and made of an electrically conductive material. The plurality of elastic connection members 166 may be connected to the ends of the above-mentioned connection protrusions 156. Therefore, the electricity from the corresponding distributed processing board may be applied to the electric discharge fin module 150 through the plurality of elastic connection members 166.

Meanwhile, the electron generation apparatus according to the embodiment of the present invention may further include an electromagnetic field generator installed in the internal space of the support structure 130 and configured to guide the movements of electrons and radicals released from the plurality of electric discharge fins 154. The electromagnetic field generator may magnetize the electrons and radicals, which are released from the electric discharge fins, by generating a strong electromagnetic field at a side at which the electric discharge plate 140 is positioned. The electromagnetic field generator may include a core made of a steel sheet material plated with zinc, and a coil wound around the core. Any electromagnetic field generator may be applied as long as the electromagnetic field generator may generate the electromagnetic field.

Therefore, according to the embodiment of the present invention, it is possible to provide the electron generation apparatus, in which the circuit module, the electric discharge fin module, and the electric discharge plate are easily coupled and uncoupled, which makes it advantageous to perform maintenance, repair, and the like.

In addition, according to the embodiment of the present invention, it is possible to provide the electron generation apparatus that has a high capacity by applying the electric discharge fin with high electrical conductivity.

In addition, according to the embodiment of the present invention, it is possible to provide the electron generation apparatus capable of adjusting the electron generation capacity in accordance with the number of tips of the protruding members provided on the electric discharge fins, the sizes of the through-holes provided in the electric discharge plate, and the distances between the electric discharge fins and the electric discharge plate.

While the specific embodiments according to the present invention have been described above, various modifications may be made without departing from the scope of the present invention. Therefore, the scope of the present invention should not be limited to the described exemplary embodiments, and should be defined by not only the claims to be described below, but also those equivalent to the claims.

While the present invention has been described above with reference to the limited embodiments and the drawings, the present invention is not limited to the embodiments and may be variously modified and altered from the disclosure by those skilled in the art to which the present invention pertains. Therefore, the spirit of the present invention should be defined only by the appended claims, and all modifications, equivalents, and alternatives fall within the scope and spirit of the present invention.

1. An electron generation apparatus comprising:
a support structure opened at one side thereof, having an empty space therein, and having a partition wall having a predetermined height and formed at a center of the other side;
an electric discharge plate provided at the other side of the support structure;
an electric discharge fin module comprising a support plate coupled to one side of the support structure, a plurality of electric discharge fins coupled to the support plate and having protruding members protruding toward the electric discharge plate, and connection protrusions provided on the support plate at positions to which the plurality of electric discharge fins is coupled; and
a circuit module disposed at one side of the electric discharge fin module and configured to apply high-voltage, high-frequency pulse power to the plurality of electric discharge fins.

2. The electron generation apparatus of claim 1, wherein the plurality of electric discharge fins comprises:
a support member coupled to the support plate; and
a protruding member protruding from the support member toward the electric discharge plate and having a plurality of tips to which an inclined surface is coupled.

3. The electron generation apparatus of claim 2, wherein the number of tips provided on the protruding member is three to ten.

4. The electron generation apparatus of claim 2, wherein the plurality of electric discharge fins is made of or coated with a conductive material including one of gold, silver, copper, aluminum, stainless, iron, and nickel.

5. The electron generation apparatus of claim 1, wherein a spacing distance between the plurality of electric discharge fins and the electric discharge plate is 3 to 40 mm.

6. The electron generation apparatus of claim 1, wherein a plurality of through-holes is formed in the electric discharge plate and corresponds to the plurality of tips in a one-to-one manner, and a size of each of the plurality of through-holes is 3 to 10 mm.

7. The electron generation apparatus of claim 1, wherein the electron generation apparatus is provided as a plurality of electron generation apparatuses stacked vertically.

8. The electron generation apparatus of claim 7, wherein a plurality of electron generation parts is stacked horizontally and vertically in an outer casing.

9. The electron generation apparatus of claim 1, further comprising:
an electromagnetic field generator installed in an internal space of the support structure and configured to magnetize electrons and radicals released from the plurality of electric discharge fins.

10. The electron generation apparatus of claim 1, wherein the circuit module comprises:
a main board;
a plurality of connection parts connected to the main board and configured to separately apply high-voltage, high-frequency pulse power to the plurality of electric discharge fins; and
a plurality of elastic connection members electrically connected to the main board, and
wherein an end of the connection protrusion is in contact with the elastic connection member.
